(19) United States
(12) Patent Application Publication
(10) Pub. No.: US 2026/0202030 A1
(43) Pub. Date: Jul. 16, 2026

(54) VEHICLE LIGHTING APPARATUS

(71) Applicant: HYUNDAI MOBIS CO., LTD., Seoul (KR)

(72) Inventor: Min Ji KIM, Yongin-si (KR)

(73) Assignee: HYUNDAI MOBIS CO., LTD., Seoul (KR)

(21) Appl. No.: 19/341,380

(22) Filed: Sep. 26, 2025

(30) Foreign Application Priority Data
Jan. 16, 2025 (KR) 10-2025-0006815

(51) Int. Cl. F21S 41/20; F21V 3/04; F21V 5/04

(52) U.S. Cl. CPC F21S 41/285; F21V 3/049; F21V 5/04

(57) ABSTRACT

A vehicle lighting apparatus and a system therefor are provided. The vehicle lighting apparatus includes a light source to generate light, a diffuser disposed in front of the light source, a lenticular device disposed in front of the diffuser, and a deposition device disposed in front of the lenticular device to allow light that has passed through the lenticular device to pass therethrough.

### CROSS-REFERENCE TO RELATED APPLICATION

This application claims priority to and the benefit under 35 USC § 119(a) of Korean Patent Application No. 10-2025-0006815, filed on January 16, 2025, in the Korean Intellectual Property Office, the disclosure of which is incorporated herein by reference in its entirety for all purposes.

### BACKGROUND

### Field of the Invention

The present invention relates to a vehicle lighting apparatus.

### Description of the Related Art

In recent years, research has been continuously conducted to improve vehicle design in order to enhance vehicle marketability. Among them, demand for improving vehicle design through vehicle lamps is increasing.

As elements for improving the design through vehicle lamps, an optical system or elements linked to the optical system are needed, and among them, there have been ongoing attempts to diversify the design through light refraction using a lenticular lens.

However, since optical design content using lenticular technology is limited to light refractive elements due to the structural characteristics of the lenticular lens applied to the lamp, there are limitations in attempts to improve the design.

Therefore, there is an increasing need to improve the design of vehicles, and more specifically, discover new designs through the presentation of three-dimensional light designs or lighting designs in both unlit and lit states, in addition to the lenticular structure.

### SUMMARY

The present invention is directed to providing an improved vehicle lighting apparatus capable of implementing a vehicle lighting design pattern together with a lenticular structure.

In a general aspect, a vehicle lighting apparatus includes: a light source configured to generate light; a diffuser disposed in front of the light source; a lenticular device disposed in front of the diffuser; and a deposition device disposed in front of the lenticular device and configured to allow light that has passed through the lenticular device to pass therethrough.

The lenticular device may include: a convex portion in which a plurality of convex shapes are continuously arranged; a pattern portion disposed between the diffuser and the convex portion and in which at least one or more patterns that are alternately arranged are formed, wherein, in a state where light is not generated by the light source, an unlit shape is implemented, and wherein, in a state where light is generated by the light source, one or more lit shapes are implemented.

The deposition device may be spaced apart in front of the lenticular device to expose a portion of the lenticular device, wherein the deposition device comprises a material that transmits light generated from the light source.

The vehicle lighting apparatus may further include a deposition supporter disposed between the lenticular device and the deposition device to support the deposition device.

The deposition supporter may be provided in a lens shape, wherein the deposition supporter may include a main body, and a protrusion that protrudes from the main body, wherein the protrusion is disposed at an interval corresponding to an interval at which the deposition device is disposed, and coupled to the deposition device.

The deposition supporter may be provided as a film.

The deposition device may be disposed on one surface of the deposition supporter at a predetermined interval in a direction in which the deposition supporter is disposed.

In another general aspect, a vehicle lighting apparatus includes: a light source configured to generate light; a diffuser disposed in front of the light source; a lenticular device disposed in front of the diffuser; and a plurality of deposition devices spaced apart from each other in front of the lenticular device and configured to allow light that has passed through the lenticular device to pass therethrough, wherein, in a state where light is not generated by the light source, an unlit shape is implemented, and wherein, in a state where light is generated by the light source, one or more lit shapes are implemented.

The lenticular device may include a convex portion in which a plurality of convex shapes are continuously arranged and a pattern portion disposed between the diffuser and the convex portion, wherein the pattern portion includes one or more patterns that are alternately arranged.

The deposition devices may be spaced apart in front of the lenticular device to expose a portion of the lenticular device, wherein the deposition devices may include a material that transmits light generated from the light source.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a view schematically illustrating a vehicle lighting apparatus according to one embodiment of the present invention;

FIG. 2A is an exploded perspective view of a lenticular unit;

FIG. 2B is a view illustrating the lenticular unit as viewed from a first viewpoint and a second viewpoint;

FIG. 3 is a view showing an unlit state of the vehicle lighting apparatus;

FIG. 4 is a view showing the vehicle lighting apparatus in a lit state as viewed from the first viewpoint;

FIG. 5 is a view showing the vehicle lighting apparatus in a lit state as viewed from the second viewpoint; and

FIG. 6 is a view illustrating another embodiment of a deposition support unit.

### DETAILED DESCRIPTION

Since the present invention may be variously modified and embodied, particular embodiments thereof will be illustrated in the drawings and described. However, this is not intended to limit the present invention to the specific embodiments, and it should be understood to include all modifications, equivalents, and substitutes included in the spirit and scope of the present invention.

Although the terms including ordinal numbers such as first, second, or the like, may be used to describe various elements, these elements are not limited by these terms. These terms are only used to distinguish one element from another element. For example, without departing from the scope of the present invention, a second element could be termed a first element, and similarly, a first element could be termed a second element. The term “and/or” includes a combination of a plurality of related listed items or any of a plurality of related listed items.

It will be understood that when an element is referred to as being “coupled” or “connected” to another element, the element may be directly coupled or connected to the other element, or intervening elements may also be present. In contrast, it will be understood that when an element is referred to as being “directly coupled” or “directly connected” to another element, there are not intervening elements present.

In the description of embodiments, when one element is described as being formed “on” or “under” another element, “on” or “under” includes both a case in which the two elements are directly in contact with each other and a case in which at least one additional element is formed to be disposed between the two elements (indirectly). Further, when expressed as “on or under”, the expression may include the meaning of not only an upward direction but also a downward direction based on one element.

The terms used in the present application are merely provided to describe specific embodiments, and are not intended to limit the present invention. The singular forms are intended to include the plural forms as well, unless the context clearly indicates otherwise. In the present application, it will be understood that terms “include,” “have,” or the like are intended to specify the presence of features, integers, steps, operations, elements, components, and/or combinations thereof stated in the specification, but do not preclude the possibility of the presence or addition of one or more other features, integers, steps, operations, elements, components, or combinations thereof in advance.

Unless otherwise defined, all terms used herein, including technical or scientific terms, have the same meaning as commonly understood by those of ordinary skill in the art to which the present invention belongs. Terms, such as those defined in commonly used dictionaries, should be interpreted as having a meaning that is consistent with their meaning in the context of the related art and will not be interpreted in an idealized or overly formal sense unless expressly so defined herein.

Hereinafter, a vehicle lighting apparatus will be described in detail with reference to the accompanying drawings, but identical or corresponding components are denoted by the same reference numerals regardless of figure numbers, and redundant descriptions thereof will be omitted.

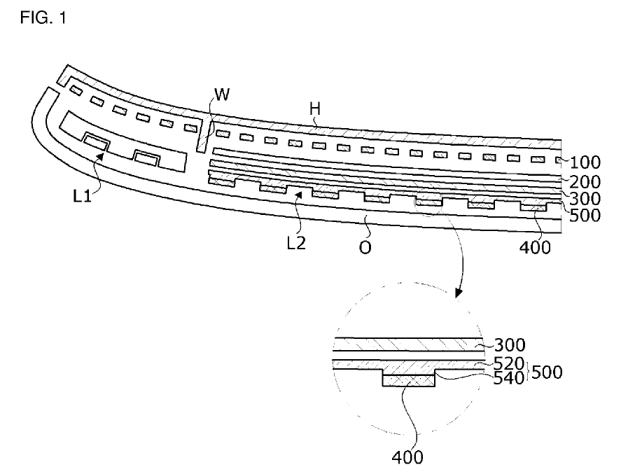

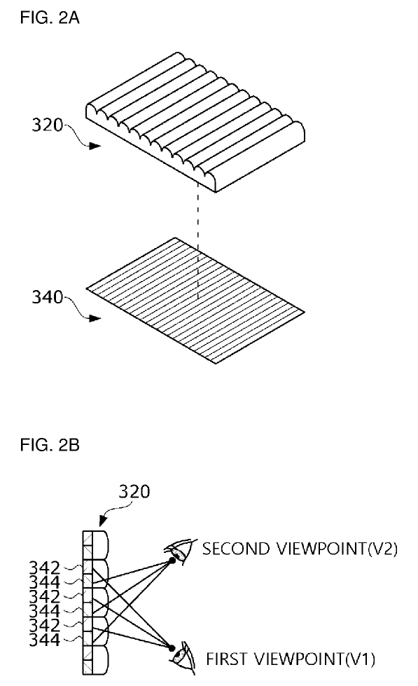

FIG. 1 is a view schematically illustrating a vehicle lighting apparatus according to one embodiment of the present invention, FIG. 2A is an exploded perspective view of a lenticular unit, and FIG. 2B is a view illustrating the lenticular unit as viewed from a first viewpoint and a second viewpoint.

Referring to FIGS. 1 to 2B, a vehicle lighting apparatus 1 according to one embodiment of the present invention may be a part of a headlight installed on a front side of a vehicle. The headlight may include a main lamp L1 and a sub-lamp L2, and among them, the vehicle lighting apparatus 1 described in the present invention may relate to the sub-lamp L2. The vehicle lighting apparatus 1 may be disposed on one side of the main lamp L1.

First, the vehicle lighting apparatus 1 may be disposed between a housing H and an outer lens O. More specifically, in a state where the outer lens O is coupled to the housing H, the vehicle lighting apparatus 1 may be disposed in a space formed by the housing H and the outer lens O. The housing H may accommodate a light source unit 100 to be described below. A partition W may be installed inside the housing H to separate the main lamp L1 and the sub-lamp L2. The outer lens O may transmit light generated by the vehicle lighting apparatus 1 so that the light may illuminate the outside of the vehicle.

The vehicle lighting apparatus 1 may be disposed in a second space S2 among a first space S1 and the second space S2 formed by the housing H and the outer lens O with the partition W of the housing H interposed therebetween. The vehicle lighting apparatus 1 may include the light source unit 100, a diffusion unit 200, a lenticular unit 300, a deposition unit 400, and a deposition support unit 500.

The light source unit 100 may be disposed inside the housing H. The light source unit 100 may be formed of a plurality of LEDs that generate light. A plurality of LEDs forming the light source unit 100 may be spaced apart from each other at predetermined intervals. Here, the light source unit 100 may be disposed in the first space S1 as well as the second space S2 formed by the housing H and the outer lens O.

The diffusion unit 200 may be disposed in front of the light source unit 100. The diffusion unit 200 may be disposed between the light source and the outer lens O. The diffusion unit 200 may be a lens that diffuses light generated from the light source unit 100. The diffusion unit 200 may be disposed in a direction in which a plurality of light source units 100 are disposed.

FIG. 2A is an exploded perspective view of the lenticular unit, and FIG. 2B is a view showing a state of the lenticular unit as viewed from a first viewpoint and a second viewpoint.

Referring to FIGS. 1, 2A, and 2B, the lenticular unit 300 may be disposed in front of the diffusion unit 200. The lenticular unit 300 may be disposed between the diffusion unit 200 and the outer lens O. The lenticular unit 300 may be made of a material that may transmit light. The lenticular unit 300 may include a convex portion 320 and a pattern portion 340.

As illustrated in FIG. 2A, the convex portion 320 may be a lens. The convex portion 320 may be composed of a combination of a flat-shaped lens and a lens in which a plurality of convex shapes are arranged in series. Here, a flat-shaped part of the convex portion 320 may be disposed to face the diffusion unit 200, and a convex shape part may be disposed to face the outer lens O. The convex portion 320 may function as a convex lens.

As illustrated in FIG. 2A, the pattern portion 340 may be disposed on the flat-shaped part of the convex portion 320. Accordingly, the pattern portion 340 may be disposed between the diffusion unit 200 and the convex portion 320. The pattern portion 340 may be a film disposed on the convex portion 320. In order to allow at least two images to be implemented, the pattern portion 340 may be a film that divides two images and then continuously and alternately arranges the two divided images (a first image 342 and a second image 344) to implement the shape thereof. That is, at least one or more patterns that are alternatively arranged may be formed in the pattern portion 340. In addition, the pattern portion 340 may be made of a material that may transmit light.

The lenticular unit 300 as described above may allow different images to be seen depending on the viewing point, as shown in FIG. 2B. More specifically, when light generated from the light source unit 100 passes through the diffusion unit 200 and then passes through the lenticular unit 300, the first image 342 may be seen as viewed from a first viewpoint V1, and a second image 344 may be seen as viewed from a second viewpoint V2.

Referring again to FIG. 1, the deposition unit 400 may be disposed in front of the lenticular unit 300. The deposition unit 400 may be disposed between the lenticular unit 300 and the outer lens O. The deposition unit 400 may transmit light that has passed through the lenticular unit 300. The deposition unit 400 may be a metal film formed through a deposition process on the deposition support unit 500. The deposition unit 400 may be made of chrome material, but is not limited thereto. The deposition unit 400 may be made of a material that may transmit light generated from the light source unit 100.

The deposition unit 400 may be spaced apart in front of the lenticular unit 300 to expose a portion of the lenticular unit 300. The structure as described above may allow the vehicle lighting apparatus 1 to have an effect of securing various views in the lit and unlit states. More specifically, since design elements that are visible through the space formed between the deposition unit 400 and the deposition unit 400 are exposed to the outside, visual diversity may be provided.

The deposition support unit 500 may be disposed between the lenticular unit 300 and the deposition unit 400 to support the deposition unit 400. The deposition support unit 500 may be made of a material that may transmit light. That is, the deposition support unit 500 may be provided in a lens shape. The deposition support unit 500 may include a main body 520 and a protrusion 540.

The main body 520 may form the exterior of the deposition support unit 500. The main body 520 may be disposed in front of the lenticular unit 300. The main body 520 may be disposed in a direction in which the lenticular unit 300 is disposed.

The protrusion 540 may protrude from the main body 520 and may be disposed at an interval corresponding to an interval at which the deposition units 400 are disposed. That is, a plurality of protrusions 540 may be disposed on the main body 520. The protrusions 540 may protrude from the main body 520 toward the outer lens O. Each of the plurality of protrusions 540 may have a width corresponding to a width of the deposition unit 400. The protrusion 540 may be coupled to the deposition unit 400 and support the deposition unit 400.

The vehicle lighting apparatus 1 according to one embodiment of the present invention may have a specific design form in the unlit state and the lit state.

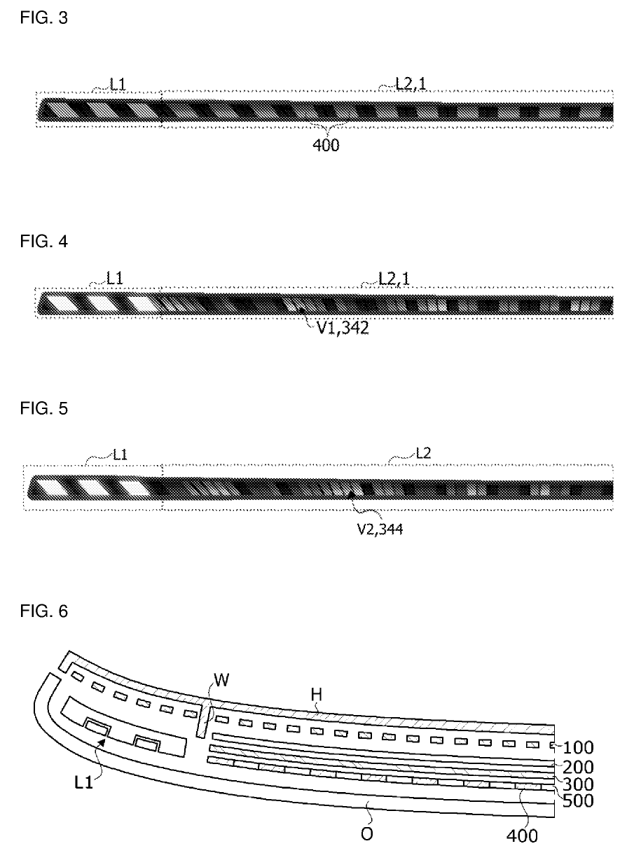

FIG. 3 is a view showing an unlit state of the vehicle lighting apparatus, FIG. 4 is a view showing the vehicle lighting apparatus in a lit state as viewed from the first viewpoint, and FIG. 5 is a view showing the vehicle lighting apparatus in the lit state as viewed from the second viewpoint.

Referring to FIG. 3, an unlit shape may be implemented in the unlit state of the vehicle lighting apparatus 1, that is, in a state where light is not generated from the light source unit 100. FIG. 3 is a view illustrating the main lamp L1 and a vehicle lighting apparatus 1 (the sub-lamp L2) according to one embodiment of the present invention arranged side by side, and it may be confirmed that both the main lamp L1 and the sub-lamp L2 are in the unlit state.

Since light is not generated in this state, the vehicle lighting apparatus 1 of the present invention, which is the sub-lamp L2, is exposed with a plurality of deposition units 400, which are the outermost component and spaces between the plurality of deposition units 400 that are separated from each other. Accordingly, it may be confirmed that the main lamp L1 and the sub-lamp L2 have the same design shape in the unlit state.

Referring to FIGS. 4 and 5, in the lit state of the vehicle lighting apparatus 1, that is, in the state where light is generated from the light source unit 100, at least one lit shape may be implemented.

First, as illustrated in FIG. 4, when light is generated from the light source unit 100 of the vehicle lighting apparatus 1 of the present invention, the light may sequentially pass through the diffusion unit 200, the lenticular unit 300, the deposition unit 400, and the deposition support unit 500, and then finally pass through the outer lens O. Accordingly, the first image 342 formed on the pattern portion 340 of the lenticular unit 300 may be seen by people looking from the first viewpoint V1 outside the outer lens O. Here, since the light passing through the space between the deposition unit 400 and the deposition unit 400 illuminates the outside of the outer lens O, the first image 342 may be seen by people looking at the first image 342 from the first viewpoint V1.

Next, as illustrated in FIG. 5, when light is generated from the light source unit 100 of the vehicle lighting apparatus 1 of the present invention, the light may sequentially pass through the diffusion unit 200, the lenticular unit 300, the deposition unit 400, and the deposition support unit 500, and then finally pass through the outer lens O. Accordingly, the second image 344 formed on the pattern portion 340 of the lenticular unit 300 may be seen by people looking from the second viewpoint V2 outside the outer lens O. Here, since the light passing through the space between the deposition unit 400 and the deposition unit 400 illuminates the outside of the outer lens O, the second image 344 may be seen by people looking at the second image 344 from the second viewpoint V2.

In this way, the vehicle lighting apparatus 1 according to one embodiment of the present invention may implement various design patterns through the lenticular unit 300 and the deposition unit 400 so that people looking at the vehicle from outside the vehicle in the unlit state and the lit state may have various images. Therefore, an effect of enhancing the design marketability of the vehicle may be obtained.

In addition, the vehicle lighting apparatus 1 according to one embodiment of the present invention may implement a design pattern having connectivity with the main lamp L1. Accordingly, a decrease in design aesthetics may be prevented, thereby preventing a decrease in the design marketability of the vehicle.

In the present embodiment, the first image 342 and the second image 344 are illustrated as being seen at the first viewpoint V1 and the second viewpoint V2, but are not limited thereto. The vehicle lighting apparatus 1 according to one embodiment of the present invention may implement various design patterns implemented at viewpoints between the first viewpoint V1 and the second viewpoint V2, and may also implement various design patterns implemented at viewpoints outside the first viewpoint V1 and viewpoints outside the second viewpoint V2.

FIG. 6 is a view illustrating another embodiment of a deposition support unit.

Referring to FIG. 6, a deposition support unit 500 may be provided in a film form. The film-shaped deposition support unit 500 may have a length corresponding to a length of the lenticular unit 300, and may be disposed in a direction in which the lenticular unit 300 is disposed. The film-shaped deposition support unit 500 may be made of a material that may transmit light. Here, a deposition unit 400 may be disposed on one surface of the deposition support unit 500 at a predetermined interval in a direction in which the deposition support unit 500 is disposed. Accordingly, while light passing through the light source unit 100 passes through the deposition unit 400 and a film unit region where the deposition unit 400 is not disposed, the first image 342 or the second image 344 of the pattern portion 340 of the lenticular unit 300 may be implemented on the outside of the outer lens O.

In addition, although not illustrated, a plurality of film-shaped deposition support units 500 may be spaced apart from each other at predetermined intervals. In this case, the deposition support units 500 may have a width corresponding to a width of the deposition unit 400 set during a manufacturing process.

According to one embodiment of the present invention, a design pattern in which different images are implemented as viewed from various viewpoints outside a vehicle through a lenticular unit and a deposition unit in an unlit state and a lit state can be implemented. Therefore, an effect of improving the design marketability of the vehicle can be obtained.

Various components may be named differently, e.g., the light source unit 100 as a light source, the diffusion unit 200 as a diffuser, the lenticular unit 300 as a lenticular device, the deposition unit 400 as a deposition device, and the deposition support unit 500 as a deposition support device. Additionally, a controller (e.g., a processor) may be configured to control the light source unit 100 to emit light or not emit light.

Although the embodiments of the present invention have been described above, it is understood that one ordinary skilled in the art can make various changes and modifications to the present invention without departing from the spirit and scope of the present invention as hereinafter claimed. Further, it should be construed that differences associated with such changes and modifications fall within the scope of the present invention defined by the accompanying claims.

What is claimed is:

1. A vehicle lighting apparatus comprising:
a light source configured to generate light;
a diffuser disposed in front of the light source;
a lenticular device disposed in front of the diffuser; and
a deposition device disposed in front of the lenticular device and configured to allow light that has passed through the lenticular device to pass therethrough.

2. The vehicle lighting apparatus of claim 1, wherein the lenticular device includes:
a convex portion in which a plurality of convex shapes are continuously arranged;
a pattern portion disposed between the diffuser and the convex portion and in which at least one or more patterns that are alternately arranged are formed,
wherein, in a state where light is not generated by the light source, an unlit shape is implemented, and
wherein, in a state where light is generated by the light source, one or more lit shapes are implemented.

3. The vehicle lighting apparatus of claim 1, wherein the deposition device is spaced apart in front of the lenticular device to expose a portion of the lenticular device, and
wherein the deposition device comprises a material that transmits light generated from the light source.

4. The vehicle lighting apparatus of claim 3, further comprising:
a deposition supporter disposed between the lenticular device and the deposition device to support the deposition device.

5. The vehicle lighting apparatus of claim 4, wherein the deposition supporter is provided in a lens shape, and
wherein the deposition supporter includes:
a main body; and
a protrusion that protrudes from the main body, and
wherein the protrusion is disposed at an interval corresponding to an interval at which the deposition device is disposed, and coupled to the deposition device.

6. The vehicle lighting apparatus of claim 4, wherein the deposition supporter is provided as a film.

7. The vehicle lighting apparatus of claim 6, wherein the deposition device is disposed on one surface of the deposition supporter at a predetermined interval in a direction in which the deposition supporter is disposed.

8. A vehicle lighting apparatus comprising:
a light source configured to generate light;
a diffuser disposed in front of the light source;
a lenticular device disposed in front of the diffuser; and
a plurality of deposition devices spaced apart from each other in front of the lenticular device and configured to allow light that has passed through the lenticular device to pass therethrough,
wherein, in a state where light is not generated by the light source, an unlit shape is implemented, and
wherein, in a state where light is generated by the light source, one or more lit shapes are implemented.

9. The vehicle lighting apparatus of claim 8, wherein the lenticular device includes:
a convex portion in which a plurality of convex shapes are continuously arranged; and
a pattern portion disposed between the diffuser and the convex portion,
wherein the pattern portion includes one or more patterns that are alternately arranged.

10. The vehicle lighting apparatus of claim 8, wherein the deposition device is spaced apart in front of the lenticular device to expose a portion of the lenticular device, and
wherein the deposition devices include a material that transmits light generated from the light source.
